(19) United States
(12) Patent Application Publication
(10) Pub. No.: US 2025/0225715 A1
(43) Pub. Date: Jul. 10, 2025

(54) METHOD OF CONTENT GENERATION FROM SPARSE POINT DATASETS

(71) Applicant: COBRA SIMULATION LTD, Bathgate (GB)

(72) Inventor: Kenny MITCHELL, Bathgate, Lothian (GB)

(73) Assignee: COBRA SIMULATION LTD, Bathgate (GB)

(21) Appl. No.: 18/874,773

(22) PCT Filed: May 22, 2023
(86) PCT No.: PCT/EP2023/063668

§ 371 Date: Dec. 13, 2024

(30) Foreign Application Priority Data
May 20, 2022 (GB) 2207459.5

(51) Int. Cl. G06T 15/20; G06T 17/20

(52) U.S. Cl. CPC G06T 15/20; G06T 17/20

(57) ABSTRACT

There is described a method of content generation from sparse point datasets, such as remote sensed aerial LiDAR scan data. Content for the landscape of a three dimensional world may be procedurally generated using signed distance field (SDF) ray marching from local adjacency aware atomic rendering primitives which facilitate interpolation from the sparse points.

### FIELD

The present invention relates to methods, systems and apparatus for generating and rendering content from sparse point datasets. In particular, for rendering an animated 3D view from real-world scan data in real-time.

### BACKGROUND

Building realistic wide scale outdoor 3D content with sufficient visual quality to observe at walking eye level or from driven vehicles is often performed with large teams of artists skilled in modelling, texturing, material shading and lighting, which typically leads to both prohibitive costs and reduced accuracy honouring the variety of real world ground truth landscapes.

LIDAR can be used to produce sets of scan data. In many cases LiDAR data is obtained from a static sensor (terrestrial laser scanner, TLS) or from a mobile sensor (mobile laser scanner, MLS). Remote sensing platforms, such as satellites, aircraft and unmanned aerial vehicles, UAVs (sometimes referred to as drones), may also be arranged to obtain scan data using LIDAR techniques. In the latter case, the overhead sensing platform necessarily requires sensor orientation that is substantially downward, rather than the lateral orientation of a static sensor or a sensor mounted on a car or truck, for example.

Terrestrial scanners, especially static scanners, typically have a higher resolution than aerial scanners but that resolution reduces significantly at greater distances from the scanner. Aerial LiDAR scanners, on the other hand, have a more consistent point resolution, across a larger area, than terrestrial scanners, making it more attractive to applications that require wider coverage. Aerial LIDAR is nevertheless often intrinsically noisy, sparse and incomplete so that interpolation is required.

### SUMMARY OF THE INVENTION

According to a first aspect of the present disclosure, there is provided a computer-implemented method for generating and rendering a view of a three dimensional, 3D, world-space, the method comprising: obtaining a sparse point dataset for the 3D world-space, the sparse point dataset having a plurality of points; classifying the points of the sparse point dataset; calculating adjacency vector data for the points; and for each point of a subset of points of the dataset, loading the point position and the corresponding adjacency vector data and reconstructing (i.e. instancing) a volume element that comprises a set of adjacency vectors directed to neighbouring points as a rasterized quad of a render target.

In certain embodiments, the method further comprises sorting the classified points into respective spatially indexed buckets, wherein said calculating adjacency vector data for the classified points is performed in each bucket.

In certain embodiments, calculating adjacency vector data includes, for each current point in a current bucket: populating a list with all other points of the same classification in the bucket and in neighbouring buckets; sorting the list in order of distance to the current point; and generating a trimmed list by including a predetermined number of the other points having the shortest distances to the current point.

In certain embodiments, calculating adjacency vector data further includes, for each current point in the current bucket, calculating directional vectors for each of the adjacent points in the trimmed list.

In certain embodiments, the calculation of adjacency data is performed in parallel for each bucket.

In certain embodiments, the calculated adjacency vector data is stored after generation.

In certain embodiments, the method further comprises: splitting the points of the data set into a plurality of spatially indexed chunks; determining which of the chunks includes a position of a camera; determining which of the plurality of chunks is a neighbour chunk based on the spatial index relative to the camera chunk; and storing the camera chunk and neighbour chunks in an active chunk array, the subset of points of the dataset being one of the plurality of active chunks.

In certain embodiments, reconstructing the volume element for points of the active chunk includes: drawing all points in each active chunk as instanced quads; and applying the quads to a model matrix.

In certain embodiments, the volume element has a shape that depends upon the classification associated with the point.

In certain embodiments, instancing the volume element for points of the active chunk includes: grouping the points of the active chunk into clusters according to the classification of the respective points; assigning one or more of the clusters to a structure; and fitting a mesh structure to the or each assigned cluster.

In a further aspect of the present disclosure there is provided a system for generating and rendering a view of a three dimensional, 3D, world-space, the system comprising: a processor; and memory including executable instructions that, as a result of execution by the processor, causes the system to: obtain a sparse point dataset for the 3D world-space, the sparse point dataset having a plurality of points; classify the points of the sparse point dataset; calculate adjacency vector data for the points; and, for each point of a subset of points of the dataset, load the point position and the corresponding adjacency vector data and reconstruct a volume element that comprises a set of adjacency vectors directed to neighbouring points as a rasterized quad of a render target. In certain embodiments, the executable instructions may cause the system to perform any of the operations of the method above.

In yet another aspect of the present disclosure there is provided a computer-readable storage medium including instructions that when executed by a computer, cause the computer to: obtain a sparse point dataset for the 3D world-space, the sparse point dataset having a plurality of points; classify the points of the sparse point dataset; calculate adjacency vector data for the points; and, for each point of a subset of points of the dataset, load the point position and the corresponding adjacency vector data and reconstruct a volume element that comprises a set of adjacency vectors directed to neighbouring points as a rasterized quad of a render target. In certain embodiments, the executable instructions may cause the system to perform any of the operations of the method above.

Various further aspects and embodiments of the invention are provided in the accompanying independent and dependent claims.

It will be appreciated that features and aspects of the invention described above in relation to the first and other aspects of the invention are equally applicable to, and may be combined with, embodiments of the invention according to the different aspects of the invention as appropriate, and not just in the specific combinations described above. Furthermore features of the dependent claims may be combined with features of the independent claims in combinations other than those explicitly set out in the claims.

### BRIEF DESCRIPTION OF DRAWINGS

Embodiments of the present invention will now be described by way of example only with reference to the accompanying drawings where like parts are provided with corresponding reference numerals and in which:

FIG. 1 illustrates a volume extensions or capsules (a “VoxSpar”) in accordance with embodiments of the present disclosure;

FIG. 2 provides a schematic diagram illustrating how points of a point cloud are sorted into a grid of spatially indexed buckets based on their positions;

FIG. 3 illustrates a visualisation of chunks being rendered around a camera relative position within a render ring neighbourhood;

FIG. 4 illustrates a visualisation with rasterized quads at the location of each point of a point cloud;

FIG. 5 illustrates bounding sphere optimization in raymarching;

FIGS. 6(a) to 6(h) illustrate various exemplary capsule-based VoxSpar primitives;

FIGS. 7(a) and 7(b) illustrate further alternative shaped VoxSpar primitives;

FIG. 8 shows a pair of visualisations illustrating the rendering of grass with and without noise;

FIG. 9 shows a pair of visualisations illustrating the effect of bulging due to the application of a smooth union function for VoxSpars representing grass;

FIG. 10 shows a pair of visualisations illustrating the rendering of tree shape with noise-based natural shape and appearance reconstruction;

FIG. 11 shows a combination of foliage VoxSpars in tree structure;

FIG. 12 shows a visualisation of the replacement of groups of points deemed to be human-made structures replaced by appropriate meshes;

FIG. 13 illustrates the emulation of a road or path with a flatter appearance than the surrounding grass;

FIG. 14 illustrates colour map sampling ground texture;

FIG. 15 illustrates the rendering of yellow grass surrounded by green grass;

FIG. 16 illustrates the “distance fog” effect;

FIG. 17 illustrates shadow map generation;

FIG. 18 illustrates screen space ambient occlusion;

FIG. 19 illustrates deferred rendering with passes writing to a colour render target and a normal render target;

FIG. 20 illustrates an exemplary sequence of iterative render passes in accordance with the present disclosure;

FIG. 21 illustrated the integration of house and car meshes into ray-marched geometry;

FIGS. 22A-22C illustrate the use of predicted depth in ray-marching;

FIG. 23 illustrates how predicted depth is calculated;

FIG. 24 illustrates the appearance of artefacts due to use of quad depth alone;

FIG. 25 illustrates the reduction of artefacts due to depth estimation;

FIG. 26 illustrates an occlusion culling artefact caused by false positive culling;

FIG. 27 illustrates false positive culling;

FIG. 28 provides a visualisation of point cloud height;

FIG. 29 illustrated the use of generative adversarial networks (GANs) to generate photorealistic images;

FIG. 30 illustrates a comparison of the results of the present solution with other known solutions;

FIG. 31 shows a further comparison between the present approach and a learned approach adopted for GANcraft;

FIG. 32 illustrates a suitable algorithm for performing point cloud spatial indexing;

FIG. 33 illustrates a suitable algorithm for performing multi-threaded adjacency calculation;

FIG. 34 illustrates a suitable algorithm for performing chunk loading and sorting;

FIG. 35 illustrates a suitable algorithm for performing chunk culling;

FIG. 36 illustrates a suitable structure clustering algorithm;

FIG. 37 illustrates an algorithm suitable for calculating predicted depth;

FIG. 38 illustrates an algorithm suitable for occlusion culling using predicted depth; and

FIG. 39 illustrates an algorithm suitable for depth re-projection.

### SUMMARY

In the present application, a process is described for automatically amplifying real-world scan data and rendering an animated 3D scene in real-time. This allows the scene to be explored at close range with high quality for training, simulation, video game and visualisation applications.

In certain embodiments, points of spatial scene data are obtained as scanned from aerial LIDAR capture methods. While point resolution may vary, the scanned points may have been captured at locations that are of the order of 1 meter apart. The spatial scene data may be obtained in real-time or in advance of processing. In certain embodiments, the spatial scene data is stored in a storage medium.

In certain embodiments, procedural 3D world generation processing is performed upon aerial LIDAR scan data. Arbitrary 3D views are thereby generated with high density shape corresponding to the original reference scanned location through point based distance field interpolated rendering of atomic rendering primitives.

Varney et al. [1] describe the introduction of the DALES data set. DALES is a set of scan data from aerial LiDAR in which each point has been hand-labelled with a classification from among eight object categories. In one embodiment, a data preparation algorithm is trained on the DALES datasets and then applied to the aerial LIDAR scan data to annotate points in the point cloud of the aerial LIDAR scan data with a respective classification.

Aerial LIDAR scan data is often noisy, sparse and incomplete. In certain embodiments, scan data may be de-noised: with data from certain points discarded from the scan data by applying a statistical outlier removal technique (such as that mentioned in [1]).

To address the sparse and incomplete nature of the scan data, certain embodiments perform interpolation.

In the present disclosure, the authors introduce a procedural 3D world generation processing technique that uses signed distance field (SDF) shape interpolation. This technique can retain sufficient core information to reconstruct large areas of terrain rapidly, primarily in a 2D image synthesis process. The reconstructions are formed of a plurality of volume elements (also referred to as volume extensions or capsules in the field of image reconstruction), which are referred to hereinafter as “VoxSpars”.

Each VoxSpar may be a capsule emanating from a central ordinal 3D location. The VoxSpar is constructed around a volume element that comprises a set of adjacency vectors to neighbouring points in the pointcloud of the scan data (where the neighbouring points have the same classification as the central point), but may take any shape derivable from the ‘star’ structured volume elements. Signed distance field (SDF) techniques are used to provide detailed shape definition.

VoxSpars may be characterised as local point based extended volume element feature descriptors. They include cached point adjacency, as well as material and shading data intended for efficiently combining in real-time rendered reconstruction of scenery. VoxSpars can therefore be seen as an analog of the inverse of computer vision image recognition feature descriptors, see D. G. Lowe [6]. Feature descriptors in computer vision provide packets of image information that encode 2D image elements (such as edges, colour patches, etc.) that can be combined and tracked for 3D object recognition and tracking. By inverse analogy, VoxSpars, are 3D shape descriptors that provide packets of 3D object elements that encode structure and appearance for efficient real-time rendered reconstruction.

A VoxSpar is an informed kind of atomic rendering primitive and forms a local adjacency aware classified particle basis decoupled from texture and topology. Suited to visual synthesis of detailed landscapes inferred from sparse unevenly distributed point clouds, they enable real-time, flexible, interpretive fragment shader rendering spanning their contained bounds.

VoxSpars encode nearest adjacent points, classification and material properties. That is, rich local surface material and shape details can be applied to simple point cloud data clusters by mapping matched ‘templates’ to high-quality pre-scanned local surfaces. Each template is procedurally varying so no two surfaces are exactly alike, and blend seamlessly together with noise and prior based distance field interpolation methods to form a complete digital twin of the real world.

VoxSpars can be used for detailed appearance reconstruction from sparse point information (e.g. 1 m spaced points). The appearance reconstruction is achieved through analytic signed distance (SDF) shaping and noise functions according to common feature classifications, e.g. trees, grass, roads, etc., and facilitates recovery of spatially varying material appearance properties including diffuse, specular, roughness, transmission, etc. properties.

The use of deep learning (e.g. through the training of deep neural networks on classified data sets such as the DALES data set) leads to informed shape and appearance reconstruction functions using the VoxSpar volume element feature descriptors which greatly improve the reconstruction speed and efficiency over the use of a “hand rolled” analytic method (i.e. a method based on teams of artists skilled in modelling, texturing, material shading and lighting).

Prior art shape completion and reconstruction are discussed in greater detail in Wu et al [2].

The use of voxlets to represent texture and shading at points in a captured point cloud is discussed in Firman et al [3].

Interpolation by point cloud completion is discussed in documents such as Hao et al. [4].

Conventional techniques for shape modelling and rendering are considered in Catmull and Clark [5].

In certain embodiments, spatial partitioning (3D grid buckets) is used when transforming raw sparse point cloud data into VoxSpars with neighbouring adjacent points data. This allows multi-threaded data transformation that is efficient for computing shaders.

In certain embodiments, the 2D image synthesis (i.e. reconstruction) is based on efficient ray marched quad SDF rendering of VoxSpars with temporal depth based occlusion culling, bounding sphere limit culling, and per chunk culling. That is to say, the resulting 2D image is constructed from projections of (quads or quadrilaterals) for each VoxSpar. Culling may be applied to restrict the number of VoxSpars for which ray marched SDF renders are performed.

Appearance and shape characteristics including road/path resolution and grass health distinction may be derived from ground colour maps obtained with the scanned data.

In certain embodiments, human-made structures are better modelled by clustering and partitioning points classified as buildings, vehicles, power lines, etc. for further shape replacement and integrated rendering.

VoxSpars furthermore allow dynamic real-time visualization of scenery through the application of time of day PCF soft shadows, atmospheric scattering and information visualization controls integrated with regular raster 3D content in Unreal Engine 5, for example.

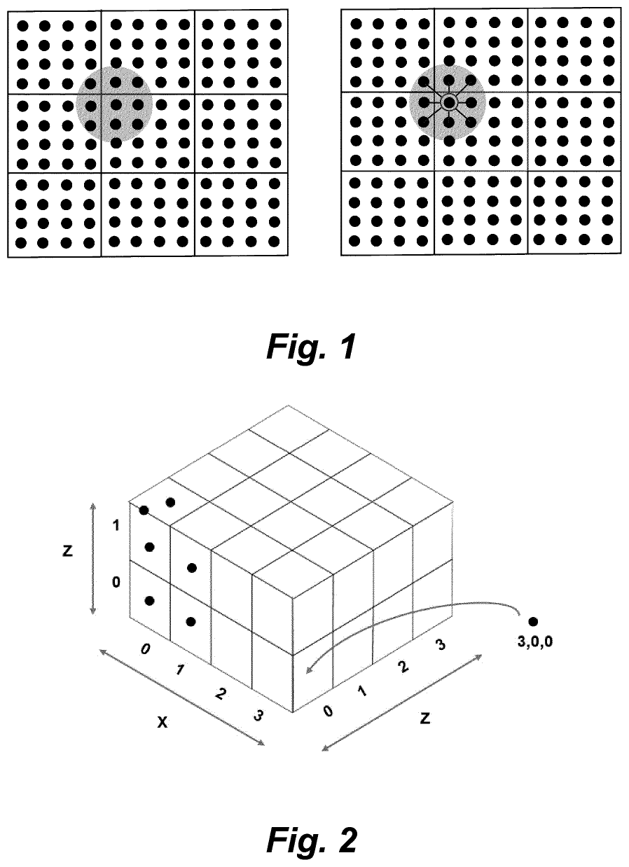

FIG. 1 shows a VoxSpar that is defined by the ‘star’ shaped adjacency between neighbouring points. Buckets from a 3D grid provide an efficient spatial partitioning to accelerate the adjacency discovery for each point among arbitrarily distributed non-uniform point locations.

### Voxspar Definition and Adjacency Process

The object recognition technique (SIFT) in D. G. Lowe [6] describes features that are necessarily and critically scale invariant for 2D image recognition. Similarly, VoxSpars encode their 3D scale topographically, through the scale of their adjacencies. Conversely, VoxSpars are characterised by their cached local shape and structure as well as by their associated encoding, which is efficient while also being sufficient to render composition of VoxSpars into the realistic rendered 3D scenery.

A VoxSpar is composed of cached local adjacency data and appearance data. A VoxSpar includes information sufficient for spatial varying material and appearance rendered reconstruction.

In simplest form, this information comes from a classification of each point, e.g. as discovered using the DALES data preparation algorithms, see [1] & [7]. The detailed composition of VoxSpars for different classifications is set out below, in particular in the sections entitled “Shape and Appearance” and “Color Map Sampling”.

Adjacency data is generated for each point by finding the closest points of the same classification. This adjacency data is used in the ray marched SDF shader to allow for smooth blending between points. By generating adjacency data, the amount of data needed to pass into the shader may be reduced since, for each point, we only require the current point's position and their adjacent points' positions to smoothly interpolate between points.

### Ray Marching VoxSpars

By interpolating only between points and their adjacent points for each VoxSpar the cost of the ray marching may be greatly reduced, since there is no need for each ray step to consider scene wide, large, overly complex primitives. At its core, the ray marching algorithm progresses as follows: for each point to be rendered only the current point's position and its adjacency data are passed in, which allows for interpolation between each point and their neighbouring points without the need for passing the entire point cloud.

### Bucketed Adjacency Processing

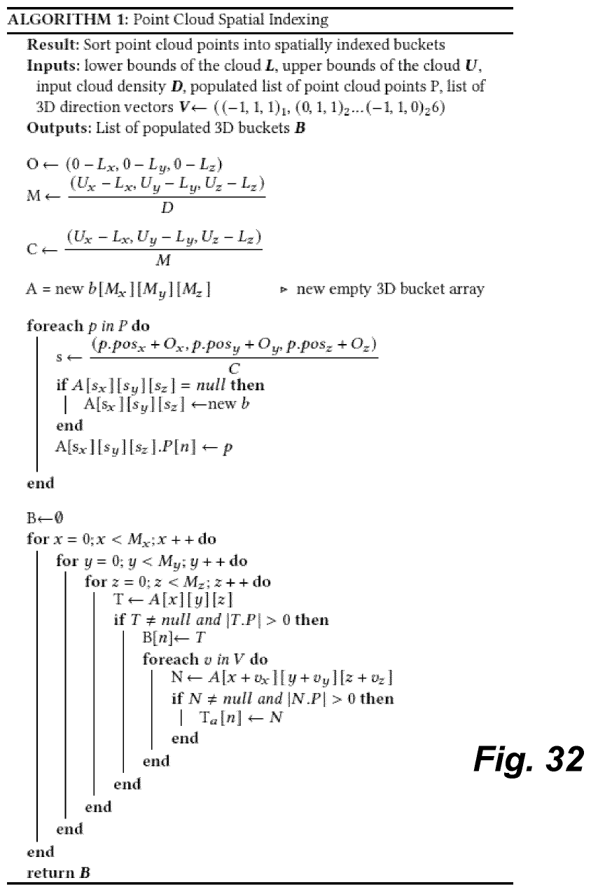

The point cloud is split into a grid of spatially indexed buckets in which the point cloud points are sorted into based on their positions (as illustrated in FIG. 2). This allows the search area to be reduced when generating adjacency by only focusing on the points within the current bucket and the buckets adjacent to it when calculating the adjacency data. By doing this the processing time may be greatly reduced as consideration is only needed for points in the current bucket and immediately neighbouring buckets for adjacent points rather than searching through the full point cloud for each point. FIG. 2 shows LiDAR points sorted into spatially indexed buckets. An example of a suitable algorithm for performing point cloud spatial indexing is given in ALGORITHM 1 (see FIG. 32).

### Multi-Threaded Adjacency Indexing

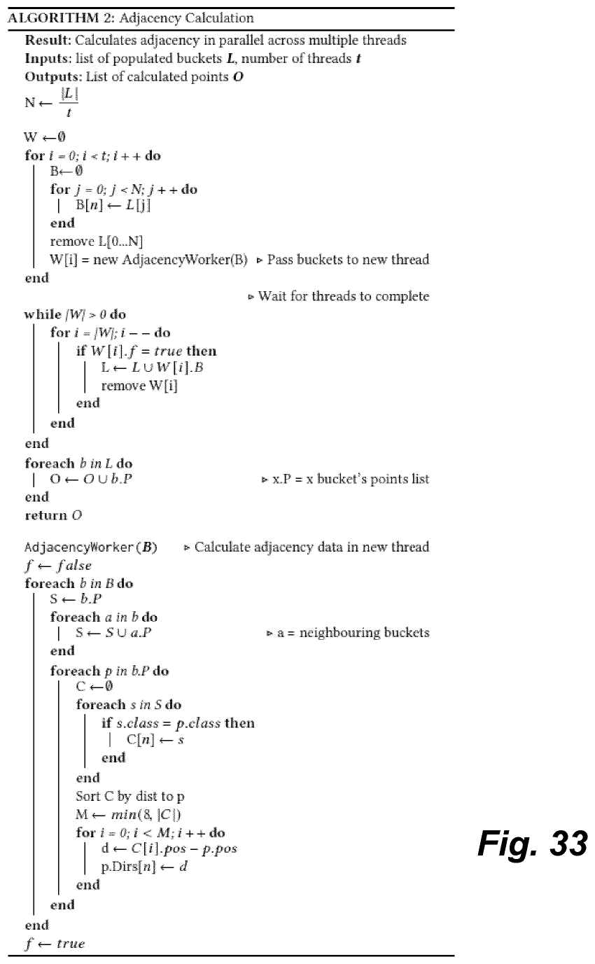

Once the buckets are populated with points they are then passed into separate threads to allow for the adjacency data to be calculated in parallel, which dramatically reduces the processing time. For each point a list is populated from all other points of the same classification in the current point's bucket and neighbouring buckets. This list is then sorted in order of distance to the current point and is then trimmed down to either the 8 closest points or the total number of points of the same classification in the search area if the number is less than 8. Then directional vectors are calculated for each of the adjacent points in this trimmed list. This process is repeated for each point in each bucket. An example of a suitable algorithm for performing multi-threaded adjacency calculation is given in ALGORITHM 2 (FIG. 33).

### Adjacency Serialization

Generating suitable adjacency data for upwards of 10,000,000 points tends to take a while (˜4 minutes) which is not ideal. To partially solve this a binary serialization implementation is used to allow for the saving of adjacency data after generation. With the serialized binary adjacency data the system can instead load in the adjacency data without the need to generate new data, which takes significantly less time (˜=30 seconds). The adjacency data may be saved as a modified binary file with the filename extension ‘.ADJA’.

### Data Streaming

When generating adjacency data for point clouds with much a much higher number of points, there is a much greater memory cost. To better handle larger data sets data can be streamed by serializing adjacency data as soon as it is generated. This allows for calculated adjacency to be stored on the disk and removed from memory, greatly reducing the overall memory cost. Through data streaming it may also be possible to load adjacency data for points that are in range of the camera, reducing the computational cost of much larger point clouds.

### Efficient Culling of Spatially Indexed Chunks

As point clouds can have millions of points, a system was developed to split them up into chunks. This way, each chunk can contain an array of points which can be instanced as quads (projected for each Voxspar) in a single draw call. This also allows for chunks of points to be loaded in and out at run-time so that the whole point cloud doesn't need to be rendered at once and culling methods such as frustum culling can be used on the individual chunks.

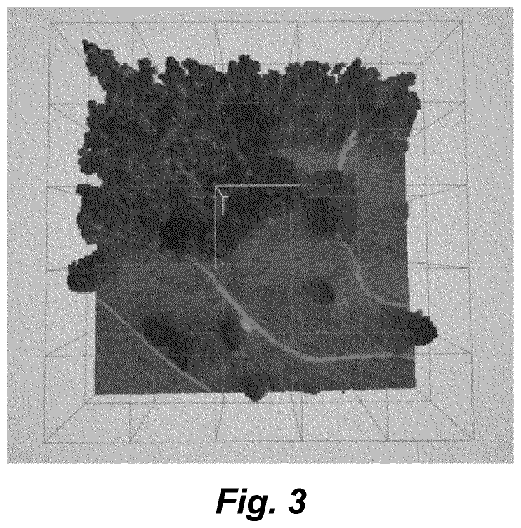

FIG. 3 illustrates a visualisation of chunks rendering around the camera's relative position with a render ring neighbourhood of 2.

### Initialising Chunks

The chunks are initialised based on the bounds of the point cloud used so they cover the whole cloud. This is done by dividing the point cloud into chunks of a specified world-space size. Each chunk, with its information such as its world position and index is stored in a list.

Sorting Points into Chunks

The points need to be assigned to their respective chunk based on their offset position within the point cloud. This is done by first translating the point's world-space position to positive space using the reverse of the world offset position, then dividing it by the worldspace size of a chunk. This gives the 3D index of the chunk that the point should be in. The 3D index is then converted to a single index and used to find the chunk and add the point to it.

$$3 {D}_{i} = ( {Pos}_{p} - {W}_{o} ) / {C}_{s} \qquad ( 1 )$$

The 3D chunk index is given by (equation 1) where 3D; is the three-dimensional index of the chunk, Posₚ is the point position, W₀ is the world offset and Cₛ is the size of a single chunk.

$$1 {D}_{i} = 3 {D}_{i} x + {W}_{s} x * ( 3 {D}_{i} y + {W}_{s} y * 3 {D}_{i} z ) \qquad ( 2 )$$

The 1D chunk index is given by (equation 2) where 1Dᵢ is the one-dimensional chunk index, 3 Dᵢ is the 3D index represented by a vector with x, y and z values and Wₛ is a 3D vector representing the scale of the world in terms of chunks.

### Loading and Unloading Chunks

The chunks are loaded in and out in real time based on the camera's position in the scene. This is done by determining the chunk that the camera occupies, or is closest to, using the same method used to find which chunk each point was in and enabling chunks around it within a given render distance—e.g. within a render ring neighbourhood of 2 as in FIG. 3.

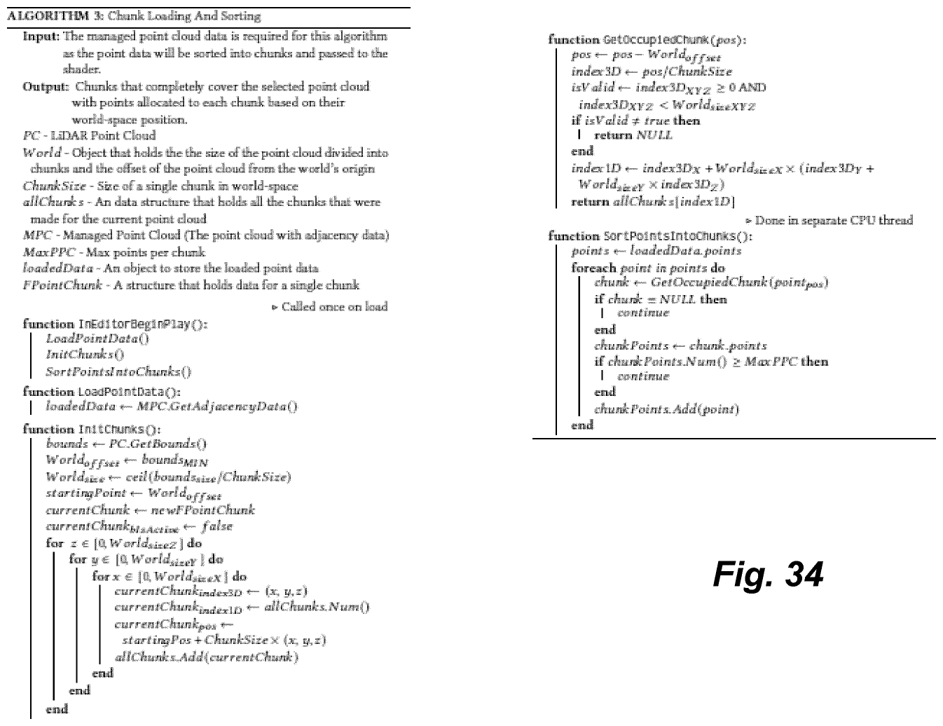

An example of a suitable algorithm for performing chunk loading and sorting is given in ALGORITHM 3 (FIG. 34). This algorithm consists of stages as follows:
(1) Load-in/generate the adjacency data for the selected point cloud.
(2) Calculate how many chunks should be made to cover the selected point cloud using the point cloud's minimum and maximum bounds.
(3) Position the chunks in a way that they line up with one another to cover the entire world-space area of the point cloud.
(4) Go through each point in the loaded point cloud data in a separate thread, sorting each of the points into their respective chunks given by their world position.
(5) Find the chunk that the camera occupies (or is closest to), if it has changed since the previous frame then the loaded chunks should change.
(6) The chunks around the chunk that the camera occupies are found by getting the 3D index of the chunk, subtracting the render distance from it to get the minimum 3D index and adding the render distance on to get the maximum 3D index. By looping through from the minimum to the maximum index, each of the surrounding chunks can be found and stored in the active chunks array.
(7) Frustum culling can then be applied to the chunks by checking whether the chunks in the active chunk array are intersecting the view frustum, if they are they are rendered and if not they are culled.

### Chunk Culling

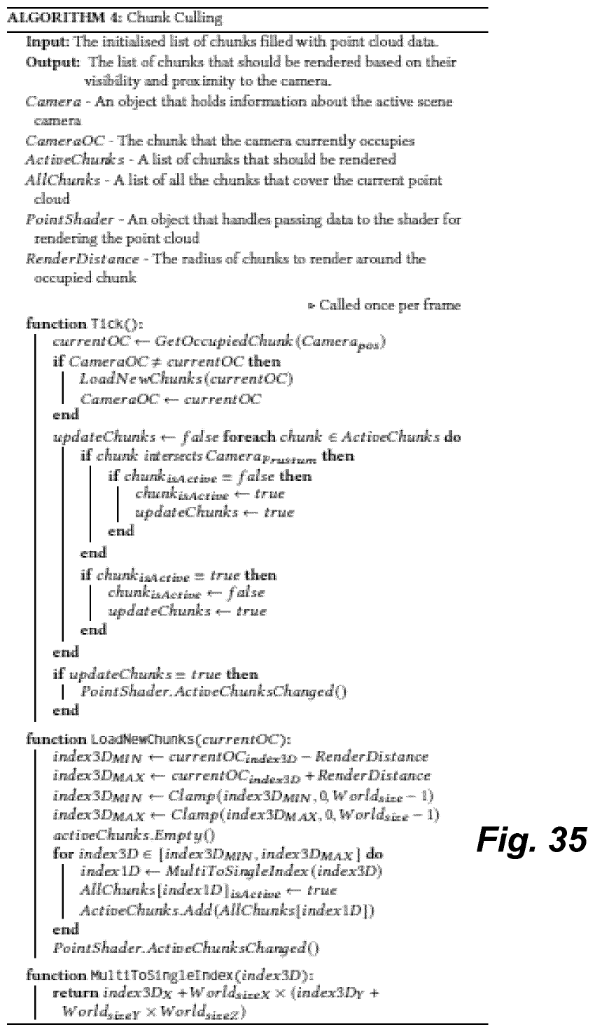

At this chunk level, whole chunks are culled according to containment within the bounds of the camera frustum. Further chunks conservatively occluded by the contents of other chunks in distance order from the camera are occlusion culled to further minimize the number of VoxSpars processed, thus minimizing the cost of work by the GPU ray marching algorithm. An example of a suitable algorithm for performing chunk culling is given in ALGORITHM 4 (FIG. 35).

### Instanced Quads

Using a post-process alone to render all of the points would require every point in the point cloud to be passed to the shader, then for every pixel on the screen, the shader would need to calculate all the SDFs (Signed Distance Functions) for every ray-march step which would be extremely inefficient. Instead, instanced quads are rasterized to a render target which is then used as a post-process effect.

### Draw Calls and Instancing

A single quad is created along with a model matrix. The model matrix obtains its rotation from the camera's view matrix: its scale is set to be large enough to cover any gaps between adjacent points in the point cloud. The translation of this model matrix is set to the world's origin by default. When it comes to rendering, each active chunk is looped through and all of the points within a chunk are drawn as instanced versions of that quad meaning that each chunk rendered counts as one draw call with 10000 quads (for example) being instanced per draw call. The positions of each of the points along with their adjacent points and classification are passed via a structured buffer called the ‘Point Buffer’.

### Using the Point Positions

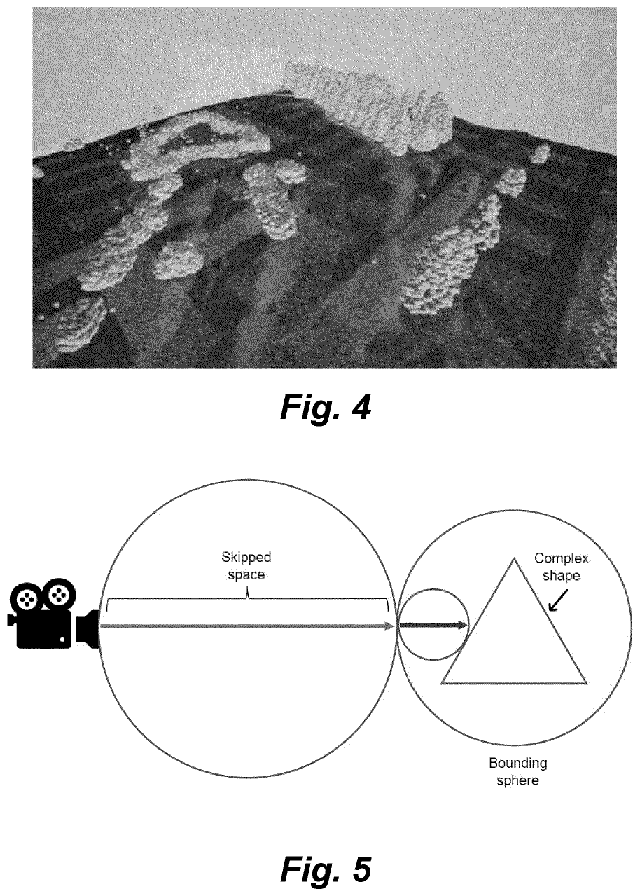

Inside the vertex shader, the vertices are multiplied by the model matrix to apply the rotation and scale. The SV-InstanceID semantic is then used to get the ID of the current instance. This can be used to index the Point Buffer to get the position of the current point instance which is added to the vertex position after it's multiplied by the model matrix to translate it to the correct position in world space. The position is then multiplied by the camera's view-projection matrix before passing to the pixel shader to put it into clip-space. This results in output such as FIG. 4, where FIG. 4 illustrates a visualization with rasterized quads at the location of each point of a point cloud.

### Shape and Appearance

In certain implementations, the majority of point clouds heavily consist of ‘natural’ classifications in the form of foliage (trees, shrubs etc.) and grass. Through the ray-marching technique it is possible to offset the surface based on noise values to create more random surfaces which is ideal for more natural materials that tend to be less consistent or smooth in shape.

### Capsule Blending

Conventionally blending between points is achieved through rendering spherical SDF primitives and performing smooth union functions between them. However, this results in bulging at sections with a higher density of points due to the functionality of the smooth union functions.

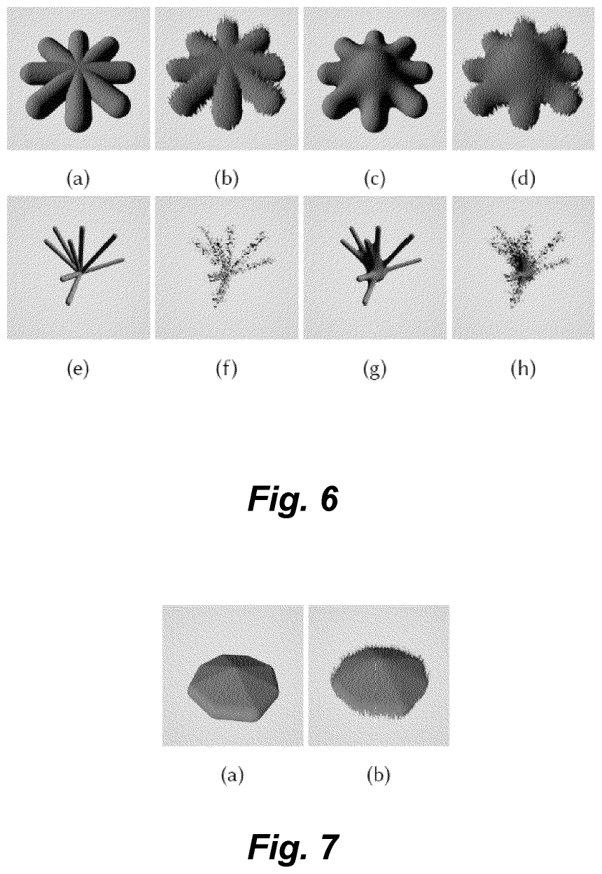

The present authors found that capsule-based SDF primitives allowed more photo-realistic blending between points while retaining a consistent radius. This is due to the fact that capsule-based SDFs essentially draw a line between two provided points and create depth around that line with a provided radius value. This allows for the creation of capsules that cover an area from a point's position to their adjacent points' positions at a consistent radius (see, for example, FIGS. 6(a) & 6(e), which show capsule-based ‘VoxSpar’ primitives for (a) grass and (e) foliage using minimum capsule depth).

Through the use of a smooth union function space between capsule shapes can be covered by blending between their surfaces. However, much like when blending spherical SDF primitives, there is a clear bulge visible at the points that the capsules overlap (compare, for instance, the smoothed grass VoxSpar of FIG. 6(c) or the smoothed foliage VoxSpar of FIG. 6(g) to the VoxSpars of FIGS. 6(a) and 6(e) respectively; see also the undesirable effect of bulging in the smoothed grass (right hand) image of FIG. 9).

$$h = min ( 1 , max ( 0 , \frac{P - O \cdot A - O}{{‖ A - O ‖}^{2}} ) ) \qquad ( 3 )$$

$$Capsule ( A ) = ‖ P - O - h ( A - O ) ‖ - r$$

$${\sum }_{i = 0}^{n} Capsule ( {A}_{i} ) \qquad ( 4 )$$

The VoxSpar SDF ‘Vₛ’ is calculated through equation (4) where capsules ‘C’ are calculated by calculating a line between origin ‘O’ and adjacent positions ‘A’ then subtracting the radius ‘r’. The VoxSpar ‘Vₛ’ shape is made by then selecting the minimum of each of the capsule depths.

### Triangle Blending

Although capsule blending is effective at filling the space between two positions in a geometry, it is not the most effective method for creating smooth surfaces between more than two positions, such as is desired for rendering smooth grass. By calculating the distance to a triangle between three provided points, instead of calculating the distance to a line segment, more horizontal space may be filled effectively. Calculated triangle depths can also be given volume by subtracting a radius value much like is done for calculating the volume of a capsule (see, for illustration, FIGS. 7(a) & 7(b), which show triangle-based VoxSpar primitives without and with noise respectively).

### Bezier Patch

A further improvement to the generation of a continuous, smooth surface could come from the implementation of bezier patches. This would allow for the calculation of curved surfaces between a varying number of adjacent positions, resulting in a more continuous surface for point classifications such as grass points. Bezier patches could be used effectively at higher levels of detail, while more basic shapes (such as triangles) could be suitable for positions further from the camera where we do not require such a high level of detail.

### Bounding Sphere Space Skipping

As natural shapes use a large amount of noise and the surface shape of each point is created through the union of multiple capsules, it is optimal to instead use a bounding sphere SDF for raymarching steps until the ray position goes within the sphere's bounds (this is illustrated in FIG. 5). This allows the raymarch to traverse the space between the camera and the point with very little computational complexity until it is within the bounds, only calculating the more complex surface when the ray position is close enough to the point. This optimizes the performance of the raymarch by reducing the need for complex calculations for every step.

### Grass

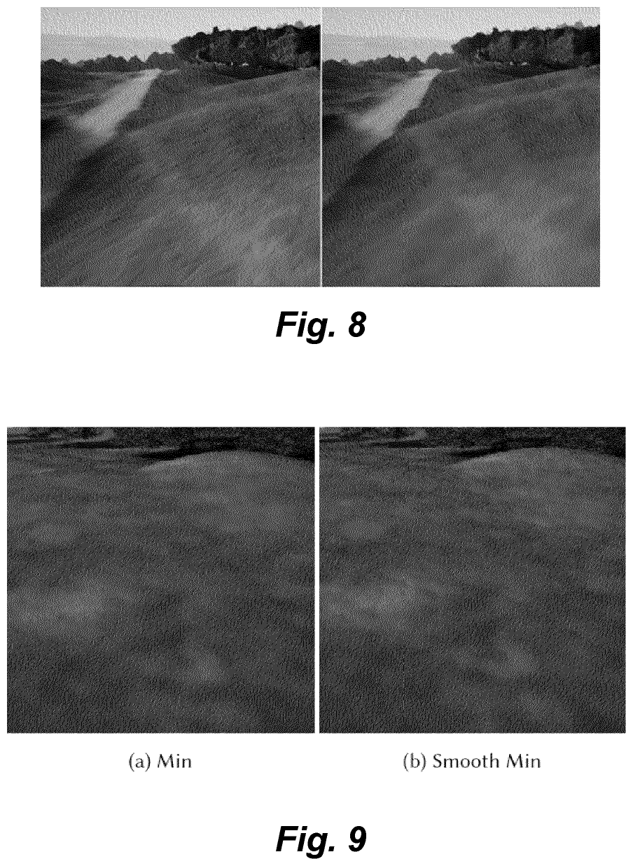

In certain embodiments, the rendering of grass is achieved by offsetting the ray position along any axis, the resulting shape's position is offset by that amount in the opposite direction. This means that by offsetting the Z (vertical) axis based on a 2D noise value which is sourced from the ray position's X,Y (horizontal) axis' it is possible to offset a shape's surface to create raised sections, essentially emulating grass blades (see for example FIGS. 6(b) and 6(d), which show (b) grass VoxSpar using min with noise, and (d) grass VoxSpar using smooth min with noise, see also FIG. 8 which compares rendering of grass without (left) and with noise (right) resulting in a natural matter appearance blending or removing observance of visible capsule adjacency structure).

Through the multiplication of the input values when offsetting the grass shape's surface it was possible to adjust both the height and width of the resulting grass blades. The height of the grass blades can be altered by multiplying the Z axis offset by a ‘grass height’ value.

### Foliage

In certain embodiments, the rendering of foliage surfaces may be achieved through offsetting the surface based on a noise value, similarly to the grass surface. However, unlike the grass shape, foliage's surface offset is instead achieved by adding and subtracting 3D noise values based on the ray position from the surface's depth rather than offsetting the ray position. This creates a leaf-like effect by offsetting the shape's surface in all directions (see for example FIGS. 6(f) and 6(h), which show (f) foliage VoxSpar using min with noise, and (h) foliage VoxSpar using smooth min with noise; see also FIG. 11 which shows a combination of foliage VoxSpars in tree structure).

### Dynamic Level of Detail (LOD)

Through the use of the raymarching technique an accurate distance is provided from the camera to the SDF surfaces. This allows for a system for dynamically handling the level of detail of geometry by checking whether the distance to a surface is below a set threshold distance before calculating or applying any complex surface distortions such as the noise surface distortion for foliage points. Through the use of this LOD system we are able to reduce the complexity of SDF calculations for complex surfaces further from the camera where there is less need for higher detail (i.e. at distances beyond the set threshold distance). This also allows for a reduction in the number of capsules being rendered for shapes further in the distance by combining the points with a lower number of adjacent points, further reducing the raymarch complexity.

### Tree Trunks

As the data being used to generate environments is aerial LiDAR there is a loss of data below overhanging surfaces. Specifically, this means that trees are comprised entirely of points that represent their leaves and do not have points to represent their trunks.

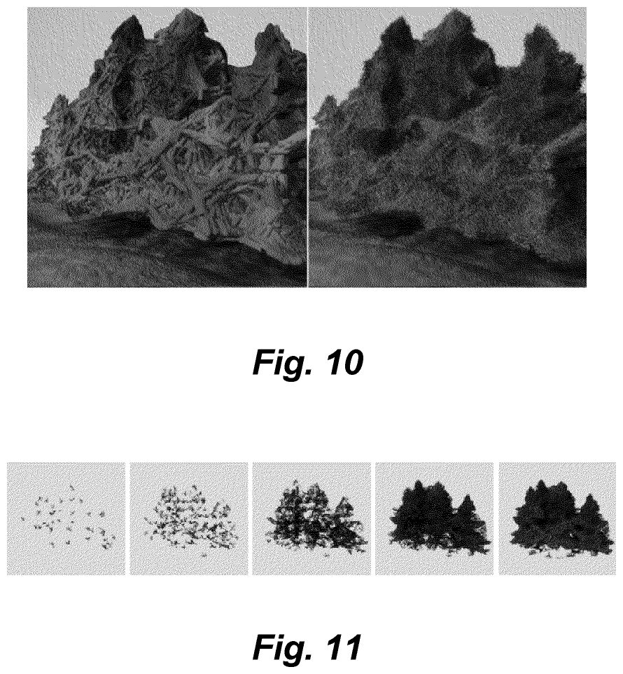

By grouping foliage points into separate tree groups, it is possible to find the centre position of each tree which allows for the procedural generation of tree trunk shapes between the foliage points and the ground. As there are no trunk points available in the point cloud, new points may instead be generated at an equal spacing between the lowest foliage point and the closest ground point to fill the space. By assigning adjacency data to each trunk point between itself and the next and previous points in the sequence we can make use of capsule SDFs to smoothly fill the space between the ground and the foliage points with a continuous capsule trunk shape. FIG. 10 illustrates the application of noise-based natural shape and appearance reconstruction to render tree shapes.

### Human-Made Structure Clustering

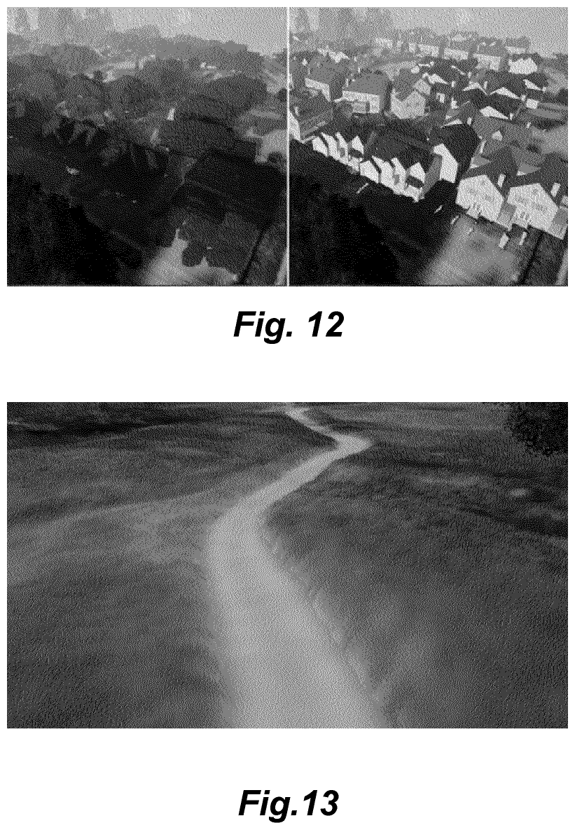

As the present implementation makes use of sparse point cloud data, there is no grouping of points into logical structures, such as buildings and vehicles. To address this lack of logical grouping, an algorithm may be implemented for the sorting of points into clusters with relatively accurate bounds. Calculating the bounds and position of structures from the sparse points allows for the spawning of meshes in the points' place. This effectively reduces the required input from artists as structure meshes may then automatically be positioned in the estimated positions of the structures. This is illustrated in FIG. 12, which shows points grouped as human-made structures replaced by appropriate meshes.

The algorithm sorts points and groups them into structures based on adjacency data. The system first sorts classified points (buildings, vehicles etc.) into lists closing the overall bounds of each. The points to be clustered into ‘structures’ are separated into lists based on their classification value, focusing on only one classification at a time. The bounds of each of the classifications is found by looping through the list of points, checking the X, Y axis' of their positions to find the highest and lowest values on both the X and Y axis. These bounds are then used to divide the overall area into ‘clusters’ in which the points are sorted based on their positions to reduce the search area and allow for effective parallel processing. Points are then sorted into ‘clusters’ in a similar way to the method used for sorting points into buckets when previously calculating adjacency data. All of the clusters are split and sent to separate workers to allow for the structure clustering algorithm to be run in parallel, reducing the computation time.

### Clustering Algorithm

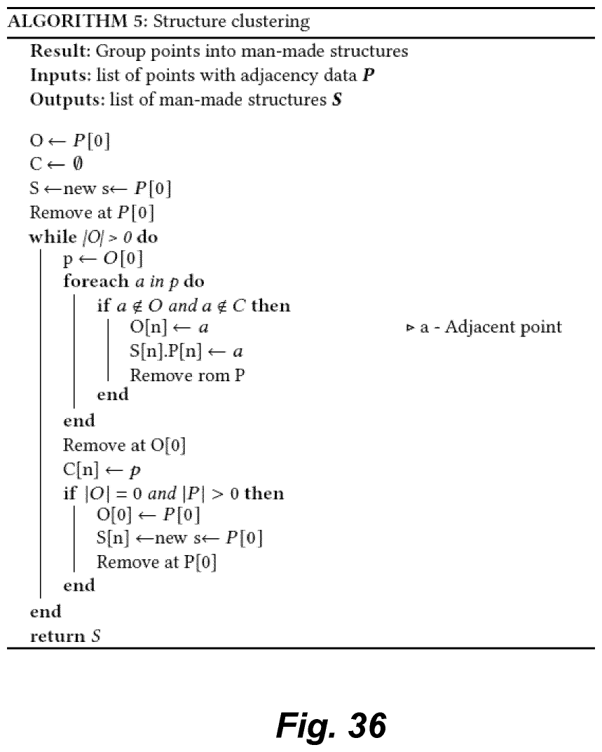

For each cluster, the algorithm groups points together into ‘structures’ via a breadth first search. Prior to looping through the cluster's list the first point in the cluster's points list is selected and is added to an open list from which the algorithm is driven and a new structure is created containing the first point. The algorithm continues to loop while the open list contains 1 or more point, ensuring that the algorithm continues to run until all points in the cluster have been sorted into structures. For each loop of the algorithm the first element of the open list is selected as the current point. The algorithm then loops through each of the current point's adjacent points, which are then added to the back of the open list and added to the current structure only if they have not yet been added to either the closed or open list and are within a distance threshold to the current point. The selected point is removed from the open list and added to the closed list once each of their adjacent points have been checked. This process continues to loop until the open list is completely emptied. If there are points in the cluster's points list that have not yet been checked, the first element of the list is moved to the open list and a new structure is created containing the point before continuing to loop through the open list. Once the open list is emptied and there are no remaining unchecked points the worker moves onto the next cluster. Once all of the clusters in each worker is complete the lists of structures is returned and appended into a single list. An example of this structure clustering algorithm is given in ALGORITHM 5 (FIG. 36).

### Structure Processing

Following completion of the clustering algorithm, the system loops through each of the structures, combining all structures with a number of points below a set threshold with the closest structure above the threshold. This effectively combines loose points that failed to be correctly clustered with the closest, most suitable structure. With the points all sorted into structures, the system then calculates the bounds of each of the structures which is then used to find the centre point by calculating the average vector position between the maximum and minimum bounds. The placement of fitted structures follows an alignment process referencing the 2D colour map identified building outline location and can be adjusted with supervised iterative refinement.

### Color Map Sampling

### Ground Texture

The ray-marched shapes are coloured with texture samples sourced from the real-world location and indexed based on the horizontal axis of the position that the ray overlaps the primitive. Parameters are used for lining up the ground texture: specifically a texture offset 2D vector parameter is used to allow for the manual positioning of the texture and a scale parameter allows for the manual scaling of the ground texture to correctly fit the point cloud. It is made possible for the automatic sampling of ground texture samples as LiDAR point clouds contain GPS coordinates for the scanned real-world location. By sampling textures from real-world locations with satellite imagery, the system is able to produce procedural images with close to photo-realistic surface textures in a reasonable amount of time.

### Ground Variation

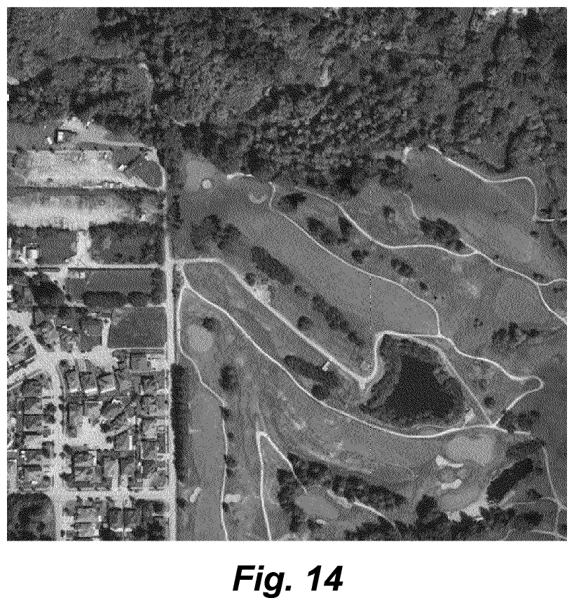

Since point clouds do not have separate classification values for different types of ground, a method for differentiating between grass and roads to alter the look of the resulting surface is required. Where sampling is from a texture sourced from satellite images of the real-world location (such as in FIG. 14), a method that compares the colour vector values may be used. The shader determines whether a ground point is to be grass or road by comparing the green value of the texture sample to the red and blue values. If the difference is above a threshold (i.e. more green) the shader handles the surface as grass and applies noise offset (as described above). However, if the difference is below the threshold, the shader instead creates a smooth surface to emulate roads and paths (see FIG. 13, where the ground points of a path texture sample are flattened).

$${S}_{g} - {S}_{r} - {S}_{b} < threshold \qquad ( 5 )$$

Grass sections are flattened based on the colour values sourced from a texture sample ‘S’ using an index based on the horizontal position. The red and blue values are then subtracted from the green value to get a total difference value, for grass this total difference value is below a set threshold, see expression (5). By only applying vertical noise to sections below the set threshold it is possible to determine which parts of the surface should road or paths and which parts should be grass. This method is effective as it allows for differentiating between ground surfaces without a significant effect on performance and without the need to perform further sub-classification on ground points.

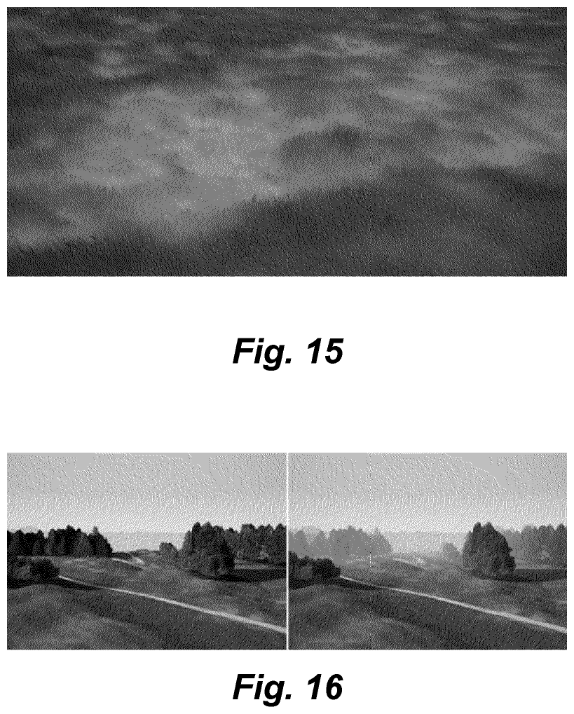

A similar technique is used to reduce the height of yellow grass based on the colour vector of the texture sample from that location (see FIG. 15, which shows the rendering of shorter thinner dried grass and taller thicker green grass that surrounds it). By subtracting the texture sample difference value calculated on the left side of expression (5) from the grass height value, sections with a lower difference (i.e. less green) may be shortened easily.

### Skybox Distance Fog

A distance fog effect may be achieved by blending between a sky cubemap and the surface colours of the raymarched shapes and the meshes in the scene based on the distance from the camera (see FIG. 16). A depth texture is passed in for both the raymarched depth and the scene depth along with colour textures for both. The depth of the scene is compared to the depth of the raymarched shapes and the colour output is selected based on the surface with the lowest depth. The shader then samples a passed-in sky texture cube at a low mip (or “mipmap”) level based on the camera's forward vector to allow for blending between the scene texture and the sky texture. The shader then blends between the sky texture and the scene texture with a lerp (linear interpolation) function based on the lower scene depth, blending more with the sky at higher depth values.

### Shadows

### Percentage Closer Filtering Soft Shadows

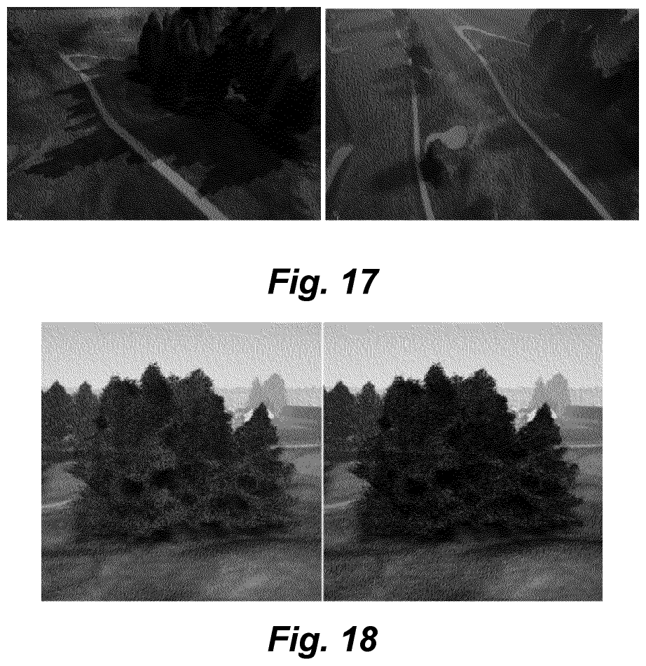

Quads may be rendered quickly and directly without further ray marching to provide shadow occlusions which can project from the sun according to time of day. With further percentage closest filtering applied to the quad shadow map we recover smooth filtered shadowed terrain. FIG. 17 shows shadow map generation using quad bounds optimization resulting in shadow-acne.

### Screen-Space Ambient Occlusion (SSAO)

Ambient occlusion is an effective way to apply perceived depth to surfaces by occluding sections of 3D geometry that would be darkened by shadow. Screen-space ambient occlusion works by sampling the depth texture from a number of random positions around a pixel's screen space position to calculate whether a pixel should be occluded or not. FIG. 18 illustrates the effect of SSAO on depth generated from VoxSpar shape reconstruction.

### Deferred Rendering

Due to areas where screen pixels are overdrawn by overlapping quads, lighting calculations may be done several times for the same pixel which can be very inefficient. Instead, in certain embodiments, the lighting is deferred to a post-process pass which only calculates lighting for pixels that were written to by the ray-marching algorithm.

### Render Targets of Scene Data

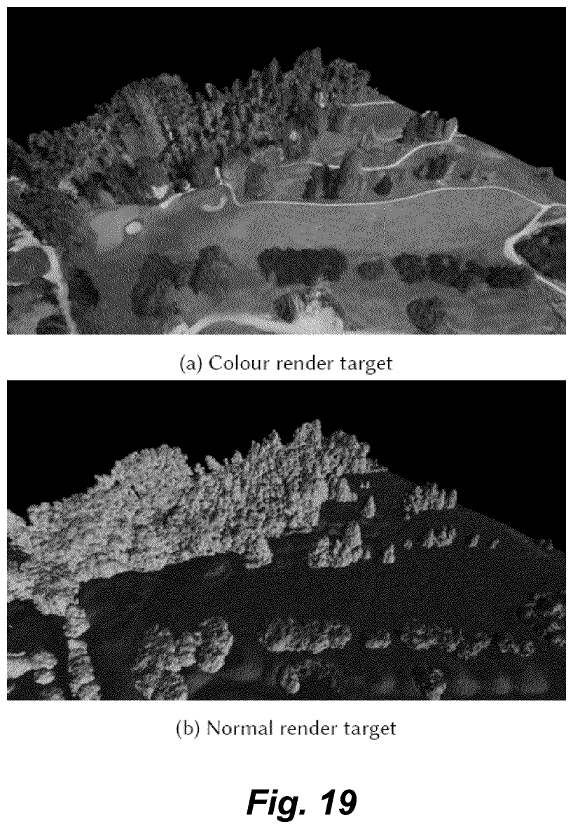

To perform deferred rendering, the colour and normal textures of the scene need to be stored when rendering the scene so they can be sampled in the lighting pass to determine the final colour of each pixel on the screen. One way to do this is by rendering the scene twice: first by rendering a pass where the colour render target is written to and then by rendering in a pass where the normals are written instead. This would be inefficient as rendering the scene twice causes a lot of overhead in terms of performance. Another way to do this is to pass multiple render targets to the pixel shader and write to both of them in the same pass. The normals can be calculated using the depth information from the ray-march algorithm and the colour is based on the classification on the point being rendered. These are written to separate render targets (see FIG. 19) in the same pass which can then be used in a separate pass to do the lighting and shadow calculations.

### Render Passes

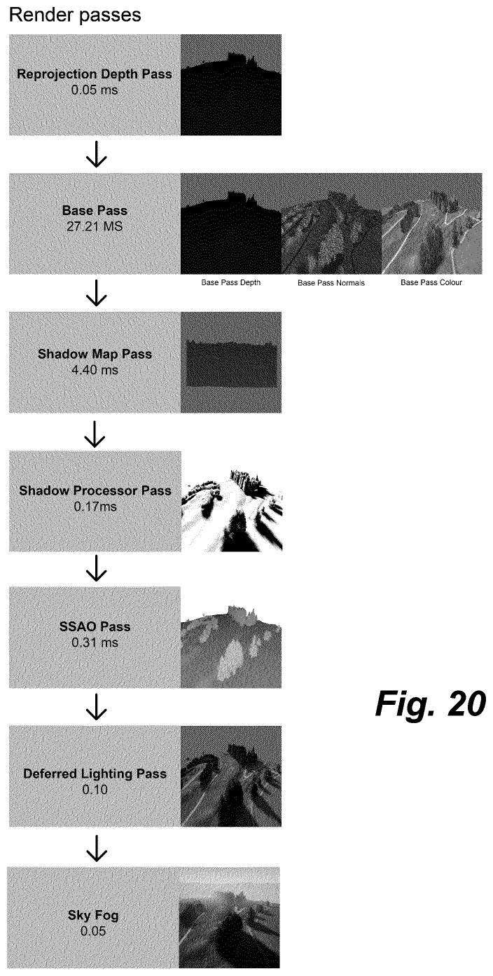

To render photo realistic worlds from a point cloud, the present authors perform many iterative render passes in order to achieve certain effects and the core CobraWorld visuals. This is done both to improve performance when re-sampling previous passes as well as in an attempt to keep the render pipeline as customizable as possible for external modification via a third party. As illustrated in FIG. 20, the render passes may include one or more of the following:

Depth Re-projection. To begin with a depth re-projection pass is performed which calculates the depth for the current pass by re-projecting a cached depth render texture from the previous frame. Then by comparing the updated view and projection matrices during the current pass a new depth texture can be generated and at ¼ of the resolution to both improve performance as well as to help aid in the reduction of artefacts gained during the re-projection stage.

Base pass. The base pass generates thousands of instanced and bill-boarded quads inside their self-contained chunks. These quads are then ray-marched into, to form the networked connections of adjacency (i.e. VoxSpars). These adjacent connections formed by set shape signed distance fields are then blended together between their neighbours to create smooth natural looking terrain. The output of this pass will contain colour, depth and the normals of the ray-marched SDFs created inside each quad.

Shadow Mapping. Typically performed after the base pass, the shadow mapping stage is a pass where currently all the instanced quads are re-rendered again except this time from the directional light's perspective to generate terrain shadows. To offset some of the performance cost of having to re-draw everything again, only the bill-boarded quads are rendered by skipping over the ray-marching stage previously done in the base pass. Despite not taking the ray-marched depth into account shadows can still remain accurate enough depending on the spatial resolution of the LiDAR scanned point cloud, a point cloud with a scan range <1M is usually good enough to provide accurate visuals since any artefacts can later be reduced via a simple blur, in a processing pass.

Shadow Map Processing. To improve the visual quality of the shadows another pass may be used to process the shadow map in a shadow processor and projection pass which calculates where the shadows should appear on the final rendered point cloud. A shadow bias offset is also used to distance the shadows by a small amount and reduce the overall shadow acne effect brought on by only comparing the depth values within the shadow map. Finally this pass applies a percentage closer filtering technique to give the shadows a better looking softness which in turn also helps to hide and remove any artefacts from the generation of the shadows, solely from just the bill-boarded quads.

SSAO. Since the shadow mapping method used in the present system makes use of a bias offset, up-close shadowing can be a bit lacking and slightly flat looking due to the fact visuals have been solely relying on the ray-marched depth to provide height variation. In a mostly standard SSAO pass, a screen-space ambient occlusion solution which slightly shadows objects that are close to each other is performed to give a bit more depth around edges, this is calculated from the normals and depth previously calculated in other passes.

Deferred Lighting. The deferred lighting pass combines the render targets from the base pass, shadow pass and the SSAO pass to apply lighting calculations to the point cloud. The lighting is done in a compute shader to eliminate the need to pass a quad through a vertex shader. This is done by sampling the normal and colour textures. If the colour's alpha value is less than 0.5, say, then the compute kernel returns without writing to the output texture as this means that the current screen-space coordinate is outside where the point cloud is rendered. Otherwise, basic diffuse lighting is performed for the current pixel using the directional light from the scene. The shadow texture is also sampled at the current screenspace coordinates and added on top of the lighting before adding the ambient light.

Fog Skybox Pass. To bring the whole world together, a final pass may be used to calculate a skybox and fog effect using the render target from the deferred lighting pass and the depth texture from the base pass. This pass is done to help blend the terrain into the virtual world by fading a mix of post processing distant fog and sampled skybox colour data to help give the appearance of a more cohesive world where the point cloud goes off into the distance, which can vastly improve the visual quality of smaller datasets.

### Scene Depth

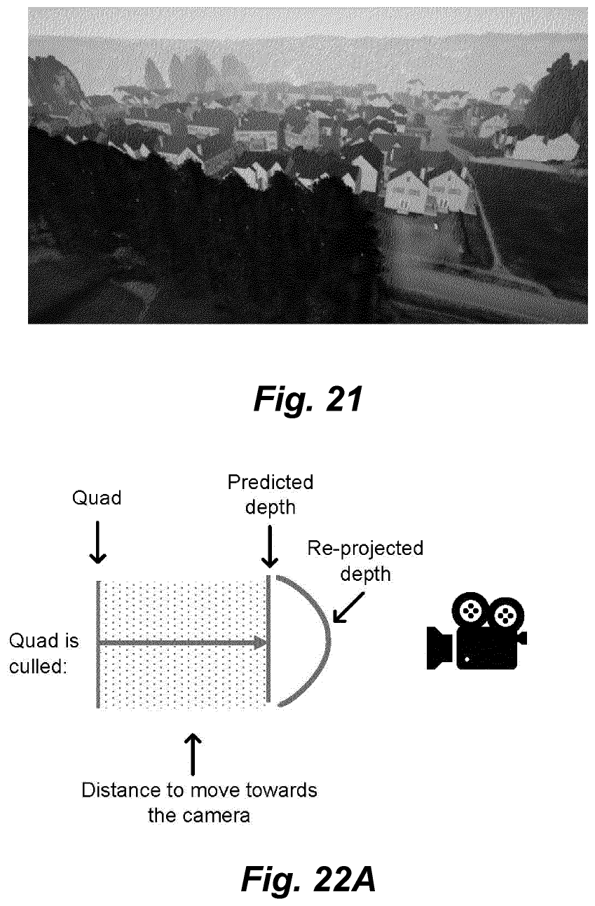

The present disclosure allows for integration with the depth from meshes that already reside within the scene. This is done by writing the depth received from the ray-march algorithm to a render target which can then be used with the scene depth texture to determine if the results from the ray-marched depth texture should be drawn to the scene or not. This way we can have smooth blending between ray-marched objects and the meshes that are placed in the scene (see FIG. 21).

### Temporal Depth-Based Occlusion Culling

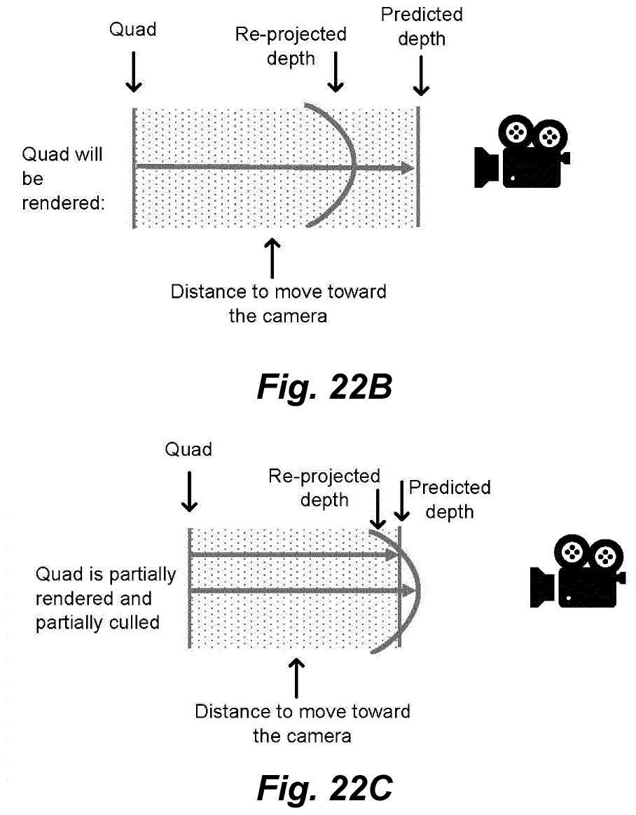

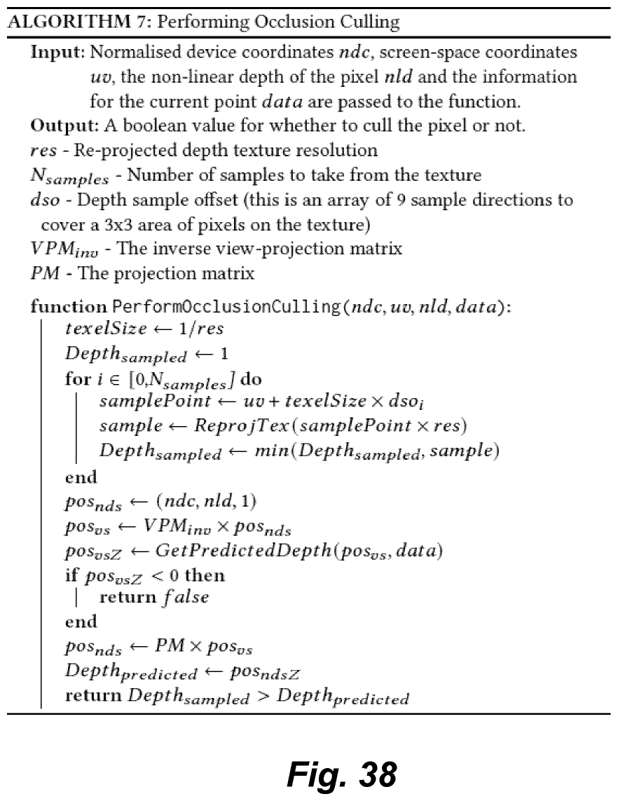

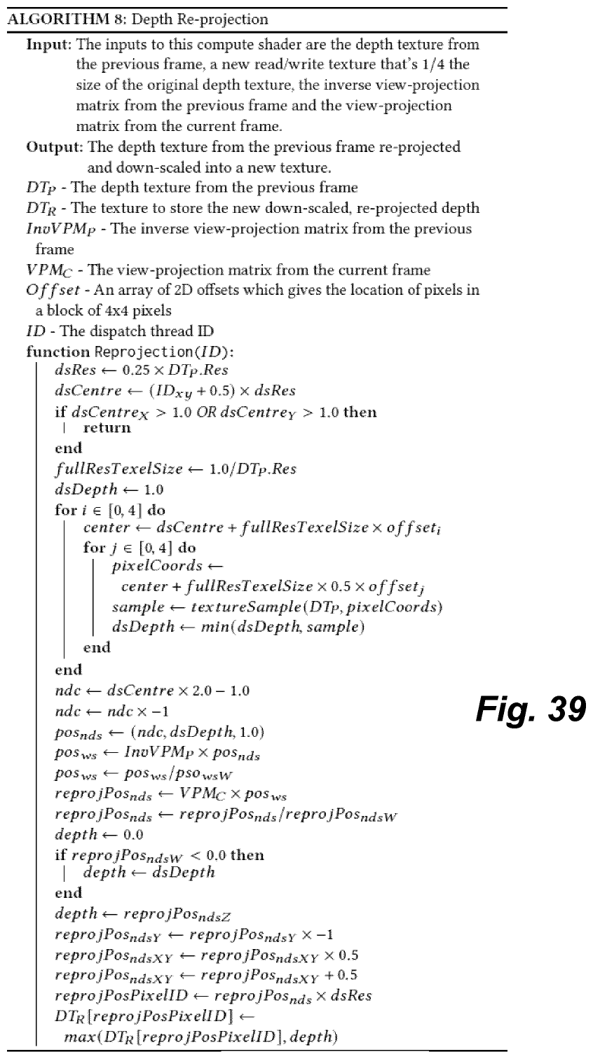

The technique used causes lots of overdraw due to quads rendering over others that have already been drawn. To combat this, an Occlusion Culling technique is used—see ALGORITHM 7 (FIG. 38). Due to how the ray-marching algorithm writes to the depth buffer, Early-Z Rejection can't be used and since there is no way to define bounding boxes without knowing the volume, neither can Occlusion Queries. Instead, the depth texture from the previous frame is re-projected to the current frame—see ALGORITHM 8 (FIG. 39), which is used to compare to the current depth to cull areas that can't be seen from the camera. Although, getting the depth of the current pixel in the shader isn't possible before performing the ray-marching calculations, so instead the depth has to be predicted based on the depth of the quad being calculated. The use of predicted depth to predict the depth written to the depth buffer in ray-marching is illustrated in FIGS. 22A to 22C.

### Predicted Depth

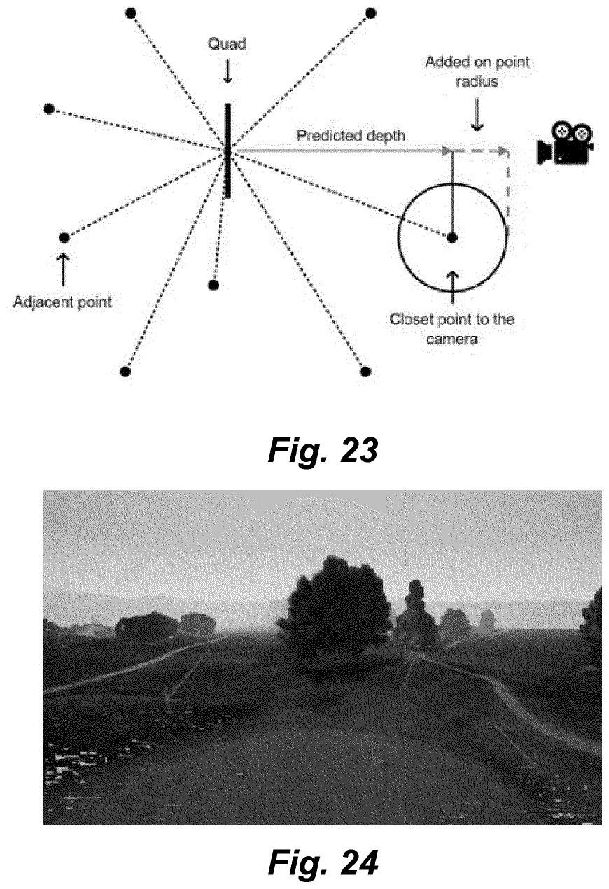

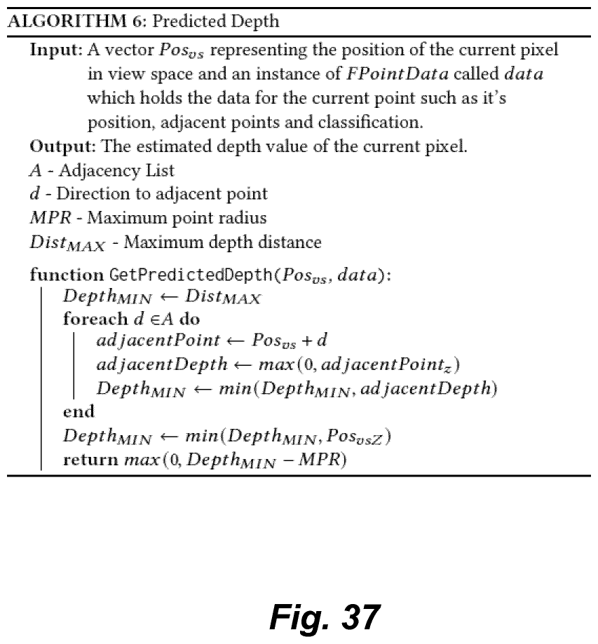

The predicted depth can be calculated using the depth of the closest adjacent point and the maximum radius of a point—see ALGORITHM 6 (FIG. 37). The maximum radius of a point is given by the maximum radius of the signed distance function that can be rendered to it (see FIG. 23, which illustrates how the predicted depth is calculated using the closest adjacent point to the camera and the maximum radius).

$${D}_{p} = min ( {a}_{1} , ... , {a}_{N} ) - MPR \qquad ( 6 )$$

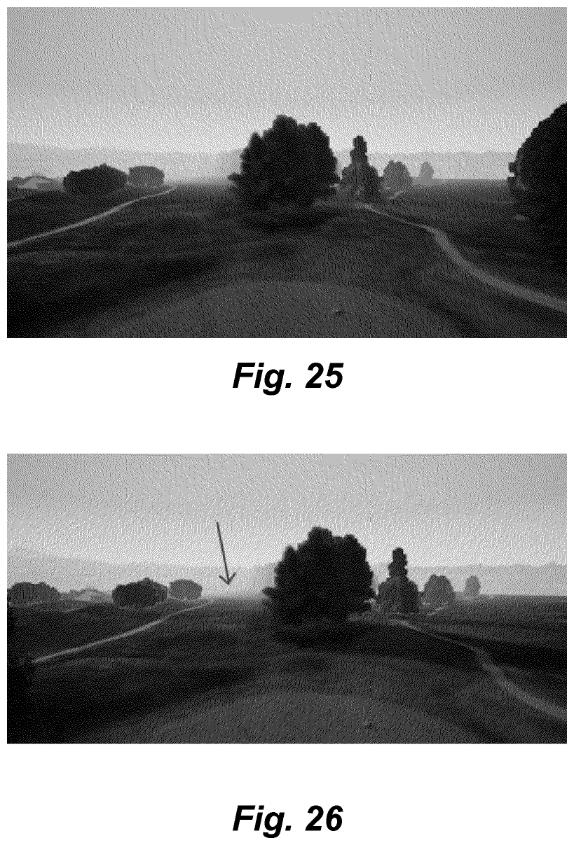

The predicted depth is given by equation (6) where Dₚ is the predicted depth, a is an element in the adjacent points array and MPR is the maximum point radius (the area around a point where geometry is rendered.) When in view-space, the position's z value is the linear-depth from the camera. The predicted depth value is set to be the new z value for this position which moves it closer to the camera. This value is then compared to the sampled depth from the re-projected depth texture. If the depth texture has a greater non-linear depth value, the pixel is culled else it is rendered. Using only the depth from the quads results in pixels being culled incorrectly (see FIG. 24, which shows artefacts caused by using just the quad depth when comparing to the re-projected depth texture) whereas predicting the depth improves on culling the correct pixels (see FIG. 25, which shows the reduction of artefacts due to this depth estimation).

### False Positive Culling

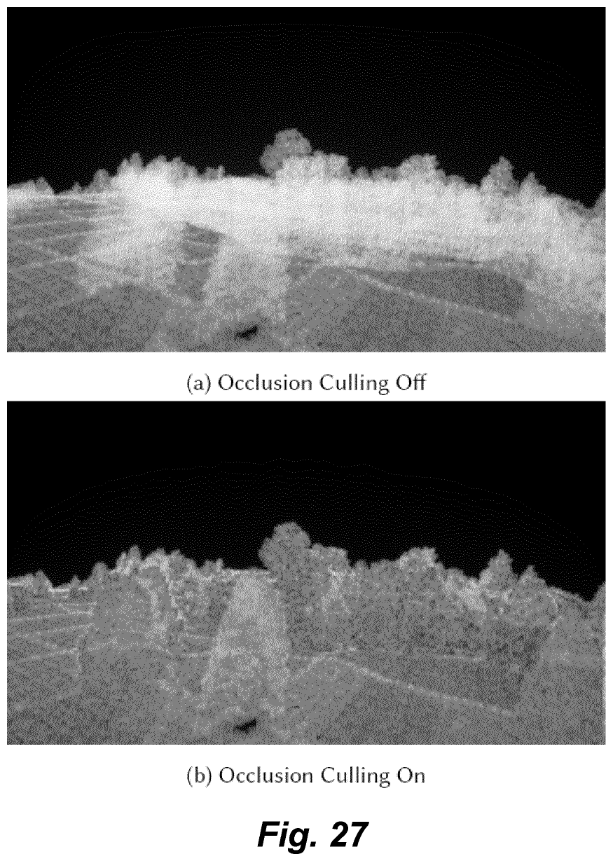

When using this technique, there can still be artefacts seen in the distance when moving the camera around as shown in FIG. 26. The presence of artefacts is due to pixels being culled that shouldn't be because the re-projected depth has trouble in areas with finer detail like the grass and trees as they have noise applied causing there to be very small gaps in-between them. To prevent these gaps from being culled, sub-sampling is used on the re-projected depth texture. By sampling a 3×3 area of pixels around the current screen-space coordinate and using the minimum value as the value to compare against the predicted depth, the artefacts are almost completely eliminated as shown in FIG. 25. This method does leave some overdraw in favour of visual accuracy, but the performance gain from it still makes it worth using. The number of pixels that have been culled using this method can be seen in FIG. 27. In FIG. 27, the point cloud is rendered with transparency where the lighter areas have more dense overdraw and the dark areas have little overdraw.

### Data Visualization

As this implementation takes point cloud data and creates realistic visual content based on point data we are able to demonstrate various data visualizations on high detail shapes that would not otherwise be possible at such a level of detail in real-time. Indeed post adjacency processing, such visualisations can be selected and modified in real-time according user analysis direction.

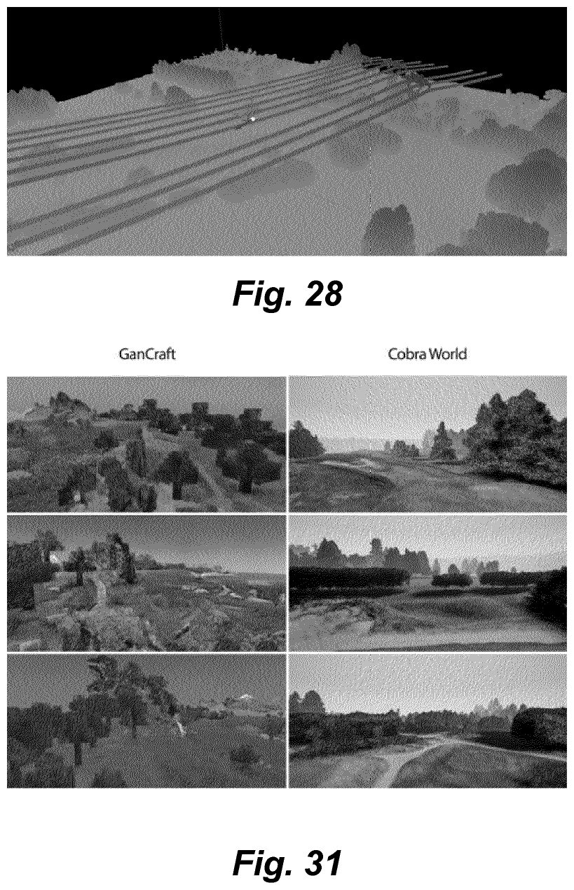

With the knowledge of the positions of each of the points in the point cloud, the creation of a height visualization is made easy (see the visualisation in FIG. 28). By finding the highest and lowest points in the cloud we are able to easily calculate a normalized height value between 0 and 1 for each of the points. We can then use this normalized height value by passing it to the point shader in which a colour is assigned to the point with a lerp function using the calculated normalized height. This colour is drawn to a render target in the same way as the previously described shaders and applied to a post-process to visualize the height of points in the point cloud.

### Deep Learned Appearance Reconstruction

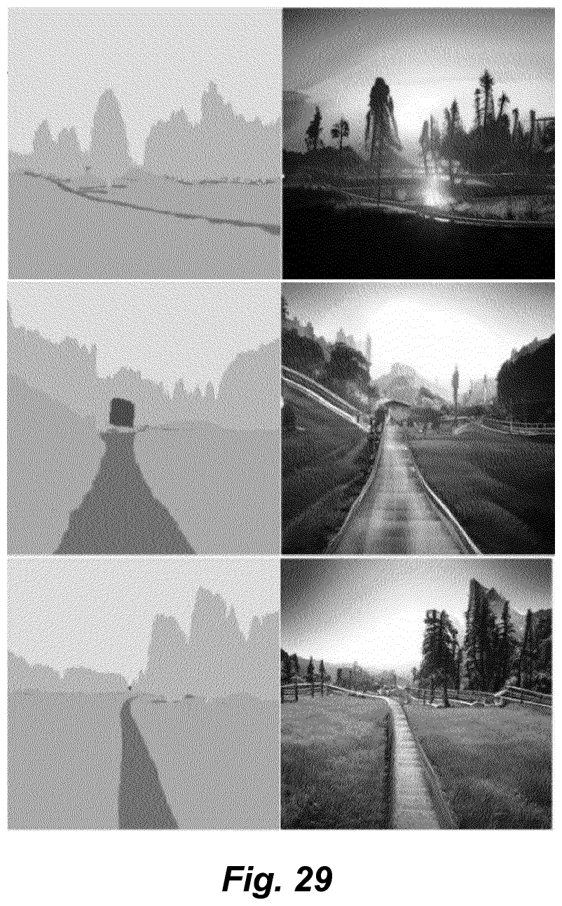

The use of neural image to image translation networks that use generative adversarial networks (GANs) to remap semantically mapped data into photo-realistic renders is presented in brief. In certain embodiments, the authors applying their own semantically mapped data as input to pix2pix, GauGan and vid2vid. FIG. 29 illustrates images generated using such GANs on the authors' detailed silhouette edges.

The present system already generates additional classification beyond what is provided by the LIDAR dataset via satellite imagery described in [1] and [7]. It also provides the adjacency data that is generated on point cloud import. With this information, points may be grouped together to form objects dynamically which can then be joined together with depth to be passed into a GAN translation network as labelled segmented data to generate an image. Many GAN models are currently making progress in temporal moving scenes.

One such GAN model is GANcraft, described in Zekun Hao, et al. [4]. GANCraft is an unsupervised neural rendering system which aims to convert the blocky world of Minecraft into photo-realistic imagery. Each Minecraft block is assigned a semantic label such as dirt, grass or water as an input. The improvements GANcraft brings compared to others include temporal stability and the support of arbitrary viewports to produce its imagery.

The authors contemplate using GAN-based image to image translation networks together with the visualization, adjacency and LIDAR classifications described above, to generate even more photo-realistic imagery that would remain temporally stable and potentially be trained on datasets local to where the LIDAR data has been sourced to generate virtual worlds without any artist input being required for its initial creation, to improve the turnaround speed of asset and level creation and generation.

### CONCLUSION

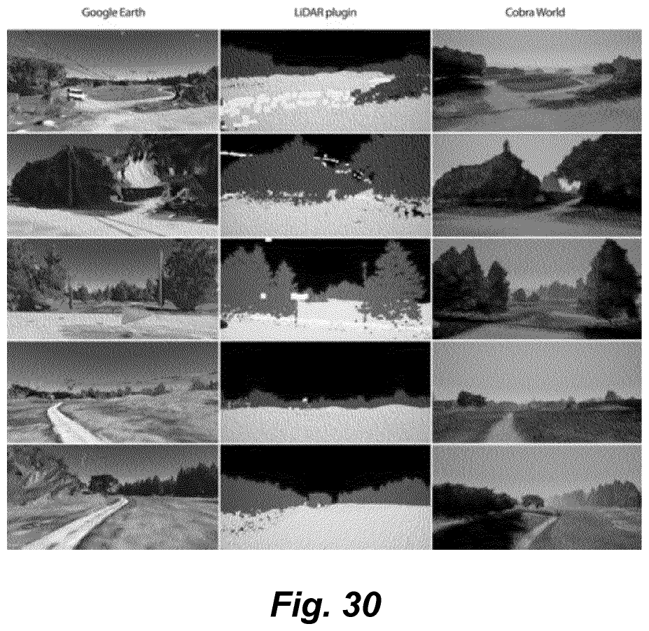

Through the comparison between the present implementation and alternative approaches such as Google Earth and GanCraft the advantage of using the present approach can be seen. In FIG. 30 a threeway comparison is made between similar walking eye level viewpoints, between Google Earth (left), the Epic Games' Unreal Engine 5.0 LiDAR plugin (middle) and the present disclosure (right). This shows a clear difference in detail at eye level between the present, raymarched approach compared to the polygonal approach shown in Google Earth and the basic coloured points shown in the Unreal Engine LiDAR Plugin. The present approach excels when viewed from eye level as the raymarching approach does not suffer from loss of detail from shorter distances which can clearly be seen when viewing Google Earth's polygonal environment from close-up.

FIG. 31 shows a further comparison between the present approach and a learned approach employed by Nvidia for their GanCraft implementation which makes use of a generative adversarial network (GAN) to generate near photo-realistic results from a voxel-based world such as Minecraft. A clear difference can be seen between the present approach and the GanCraft implementation: GanCraft's blocky nature can be seen in certain areas since it derives from a purely voxel-based environment. However, the present implementation does not suffer from the same blocky visual due to the smooth look of the raymarching technique.

### REFERENCES

[1] Nina Varney, Vijayan K Asari, and Quinn Graehling. DALES: A large-scale aerial LIDAR data set for semantic segmentation. In Proceedings of the IEEE/CVF Conference on Computer Vision and Pattern Recognition Workshops, pages 186-187, 2020.
[2] Jiajun Wu, Chengkai Zhang, Xiuming Zhang, Zhoutong Zhang, William T. Freeman, and Joshua B. Tenenbaum. Learning shape priors for single-view 3d completion and reconstruction. In Proceedings of the European Conference on Computer Vision (ECCV), September 2018.
[3] Michael Firman, Oisin Mac Aodha, Simon Julier, and Gabriel J Brostow. Structured Completion of Unobserved Voxels from a Single Depth Image. In Computer Vision and Pattern Recognition (CVPR), 2016.
[4] Zekun Hao, Arun Mallya, Serge J. Belongie, and Ming-Yu Liu. Gancraft: Unsupervised 3d neural rendering of Minecraft worlds. 2021 IEEE/CVF International Conference on Computer Vision (ICCV), pages 14052-14062, 2021.
[5] E. Catmull and J. Clark. Recursively Generated B-Spline Surfaces in Arbitrary Topological Meshes, page 183-188. Association for Computing Machinery, New York, NY, USA, 1998.
[6] D. G. Lowe. Object recognition from local scale-invariant features. In Proceedings of the Seventh IEEE International Conference on Computer Vision, volume 2, pages 1150-1157 vol. 2, 1999.
[7] Nina M. Singer and Vijayan K. Asari. DALES objects: A large scale benchmark dataset for instance segmentation in aerial LIDAR. IEEE Access, pages 1-1, 2021.

1. A computer-implemented method for generating and rendering a view of a three dimensional, 3D, world-space, the method comprising:
obtaining a sparse point dataset for the 3D world-space, the sparse point dataset having a plurality of points;
classifying the points of the sparse point dataset;
calculating adjacency vector data for the classified points; and
for each point of a subset of points of the dataset, loading the point position and the corresponding adjacency vector data and reconstructing a volume element that comprises a set of adjacency vectors directed to neighbouring points as a rasterized quad of a render target.

2. The method of claim 1, further comprising:
sorting the classified points into respective spatially indexed buckets; wherein said calculating adjacency vector data for the classified points is performed in each bucket.

3. The method of claim 2, wherein calculating adjacency vector data includes, for each current point in a current bucket:
populating a list with all other points of the same classification in the bucket and in neighbouring buckets;
sorting the list in order of distance to the current point; and
generating a trimmed list by including a predetermined number of the other points having the shortest distances to the current point.

4. The method of claim 3, wherein calculating adjacency vector data further includes, for each current point in the current bucket, calculating directional vectors for each of the adjacent points in the trimmed list.

5. The method as claimed in claim 2, wherein the calculation of adjacency vector data is performed in parallel for each bucket.

6. The method as claimed in claim 1, wherein the calculated adjacency vector data is stored after generation.

7. The method as claimed in claim 1, further comprising:
splitting the points of the data set into a plurality of spatially indexed chunks;
determining which of the chunks includes a position of a camera;
determining which of the plurality of chunks is a neighbour chunk based on the spatial index relative to the camera chunk; and
storing the camera chunk and neighbour chunks in an active chunk array, the subset of points of the dataset being one of the plurality of active chunks.

8. The method as claimed in claim 7, wherein reconstructing the volume element for points of the active chunk includes:
drawing all points in each active chunk as instanced quads; and
applying the quads to a model matrix.

9. The method as claimed in claim 8, wherein the volume element has a shape that depends upon the classification associated with the point.

10. The method as claimed in claim 7, wherein reconstructing the volume element for points of the active chunk includes:
grouping the points of the active chunk into clusters according to the classification of the respective points;
assigning one or more of the clusters to a structure; and
fitting a mesh structure to the or each assigned cluster.

11. A system for generating and rendering a view of a three dimensional, 3D, world-space, the system comprising:
a processor; and
memory including executable instructions that, as a result of execution by the processor, causes the system to:
obtain a sparse point dataset for the 3D world-space, the sparse point dataset having a plurality of points;
classify the points of the sparse point dataset;
calculate adjacency vector data for the points; and
for each point of a subset of points of the dataset, load the point position and the corresponding adjacency vector data and reconstruct a volume element that comprises a set of adjacency vectors directed to neighbouring points as a rasterized quad of a render target.

12. A computer-readable storage medium including instructions that when executed by a computer, cause the computer to:
obtain a sparse point dataset for the 3D world-space, the sparse point dataset having a plurality of points;
classify the points of the sparse point dataset;
calculate adjacency vector data for the points; and
for each point of a subset of points of the dataset, load the point position and the corresponding adjacency vector data and reconstruct a volume element that comprises a set of adjacency vectors directed to neighbouring points as a rasterized quad of a render target.

13. The storage medium as claimed in claim 12, wherein the storage medium is a non-transitory computer-readable storage medium.
